(19) United States
(12) Patent Application Publication
(10) Pub. No.: US 2026/0212718 A1
(43) Pub. Date: Jul. 23, 2026

(54) VEHICLE ELECTRONIC KEY

(71) Applicant: Alps Alpine Co., Ltd., Tokyo (JP)

(72) Inventor: Ryo TAKAHASHI, Miyagi-ken (JP)

(21) Appl. No.: 19/451,275

(22) Filed: Jan. 16, 2026

(30) Foreign Application Priority Data
Jan. 21, 2025 (JP) 2025-008715

(51) Int. Cl. G07C 9/00

(52) U.S. Cl. CPC G07C 9/00944; G07C 2009/00793; G07C 2009/00952; G07C 2009/00984

(57) ABSTRACT

A vehicle electronic key includes a housing including a key accommodating compartment, a first opening, and a first accommodating compartment configured to accommodate a first battery; a wireless communication unit accommodated within the housing; and an emergency key including a key plate accommodated in the key accommodating compartment and a grip portion attached to the key plate. The grip portion includes a second opening, a second accommodating compartment configured to accommodate a second battery, and a positioning portion that, when the key plate is accommodated in the key accommodating compartment, comes into contact with the first battery accommodated in the first accommodating compartment. When the key plate is accommodated in the key accommodating compartment, the first opening is blocked by the grip portion, and the first accommodating compartment and the second accommodating compartment are contained within an enclosed space closed by the housing and the grip portion.

### CLAIM OF PRIORITY

This application claims benefit of Japanese Patent Application No. 2025-008715 filed on January 21, 2025, which is hereby incorporated by reference.

### BACKGROUND OF THE INVENTION

### Field of the Invention

The present disclosure relates to vehicle electronic keys.

### Description of the Related Art

There has conventionally been provided a remote key including a wireless transmission unit configured to wirelessly transmit a lock/unlock signal, a mechanical key unit having an insertion portion to be inserted into a key cylinder, a housing that accommodates the wireless transmission unit and the insertion portion of the mechanical key unit, a button-type battery for supplying electric power to the wireless transmission unit, and a battery accommodating compartment configured to accommodate the button-type battery. The mechanical key unit is configured to move relative to the housing so that the insertion portion can be inserted into the key cylinder (e.g., see Japanese Unexamined Patent Application Publication No. 2016-020579).

In a known remote key, although battery replacement can be easily performed, the usable time until battery replacement is short because a single button-type battery is used as a power source, and the radio-wave transmission range is also short.

### SUMMARY OF THE INVENTION

The present disclosure provides a vehicle electronic key in which battery replacement can be easily performed, the usable time until battery replacement is long, or the radio-wave transmission range is long.

A vehicle electronic key according to an embodiment of the present disclosure includes a housing including a key accommodating compartment, a first opening, and a first accommodating compartment that communicates with the first opening and is configured to accommodate a first battery; a wireless communication unit accommodated within the housing; and an emergency key including a key plate accommodated in the key accommodating compartment and a grip portion attached to the key plate. The grip portion includes a second opening, a second accommodating compartment that communicates with the second opening and is configured to accommodate a second battery, and a positioning portion that, when the key plate is accommodated in the key accommodating compartment, comes into contact with the first battery accommodated in the first accommodating compartment. When the key plate is accommodated in the key accommodating compartment, the first opening is blocked by the grip portion, and the first accommodating compartment and the second accommodating compartment are contained within an enclosed space closed by the housing and the grip portion.

### BRIEF DESCRIPTION OF THE DRAWINGS

FIG. 1A is a diagram illustrating a configuration of a vehicle electronic key according to an embodiment;

FIG. 1B is a diagram illustrating a configuration of the vehicle electronic key according to the embodiment;

FIG. 2A is a cross-sectional view illustrating an example of the configuration taken along line IIA-IIA in FIG. 1A;

FIG. 2B is a diagram illustrating an example of a state where an emergency key is pulled out of a housing in FIG. 2A;

FIG. 3A is a diagram illustrating an example of the configuration of the emergency key;

FIG. 3B is a cross-sectional view illustrating an example of the configuration taken along line IIIB-IIIB in FIG. 3A;

FIG. 4 is a diagram illustrating an example of a state where a lower housing is removed from the vehicle electronic key;

FIG. 5 is a diagram illustrating an example of a state where the emergency key is removed from the housing of the vehicle electronic key;

FIG. 6A is a diagram illustrating an example of operations of a positive terminal and a protrusion of the emergency key when inserting a battery into a first accommodating compartment; and

FIG. 6B is a diagram illustrating an example of operations of the positive terminal and the protrusion of the emergency key when inserting the battery into the first accommodating compartment.

### DESCRIPTION OF THE PREFERRED EMBODIMENTS

Embodiments to which a vehicle electronic key according to the present disclosure is applied will be described below. Hereinafter, an XYZ coordinate system is defined for the following description. The direction parallel to the X-axis (the X-direction), the direction parallel to the Y-axis (the Y-direction), and the direction parallel to the Z-axis (the Z-direction) are orthogonal to one another. For convenience of description, the -Z direction side may be referred to as the lower side or below, and the +Z direction side may be referred to as the upper side or above. However, these terms do not represent universal upper and lower orientations. The term "plan view" refers to a view as seen in the X-Y plane. Hereinafter, for ease of understanding the structure, the lengths, widths, thicknesses, and other dimensions of the individual components may be illustrated in exaggerated manner.

### Embodiments

### Vehicle Electronic Key 100

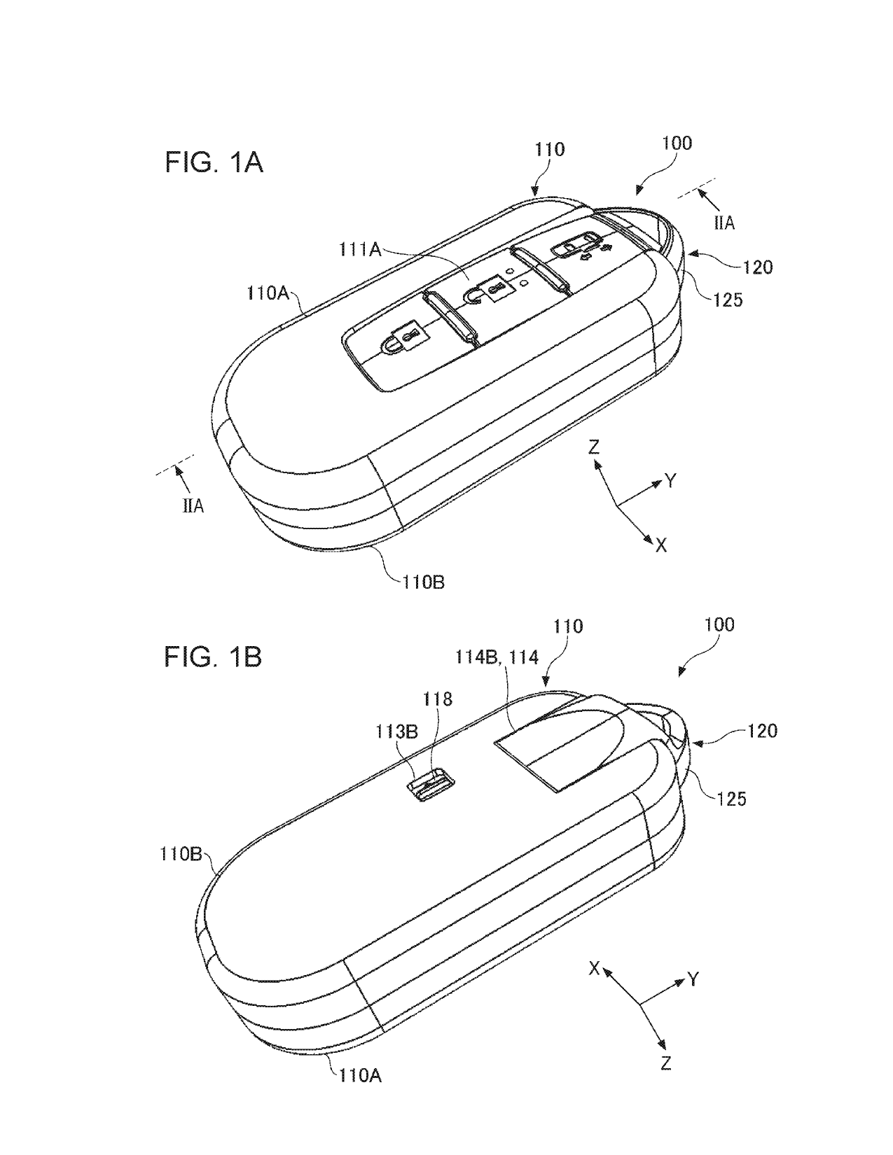

FIGS. 1A and 1B are diagrams illustrating a configuration of a vehicle electronic key 100 according to an embodiment. The vehicle electronic key 100 includes a housing 110, an emergency key 120, a substrate 130, a wireless communication unit 140, push-button switches 150, sealing members 160A and 160B, and batteries 170A and 170B. The battery 170A is an example of a first battery, and the battery 170B is an example of a second battery. The batteries 170A and 170B are button batteries, as an example.

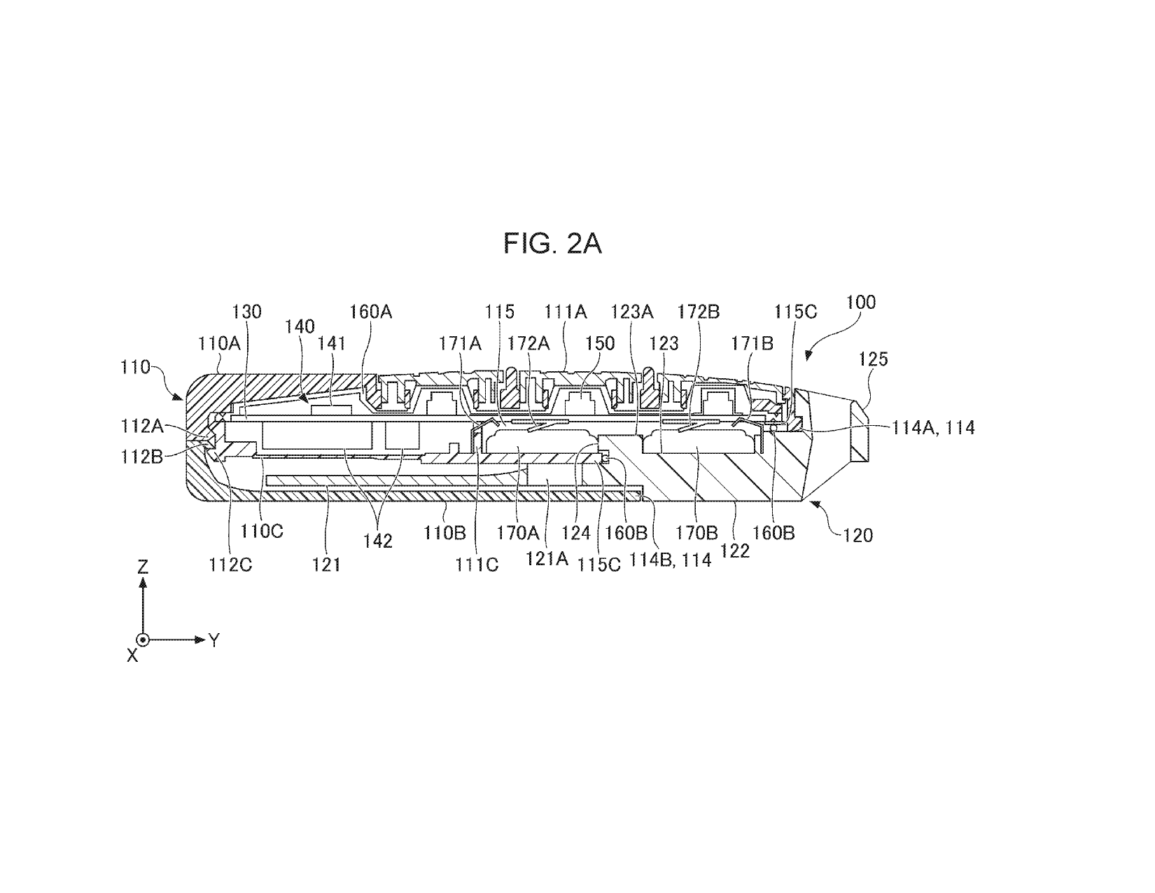

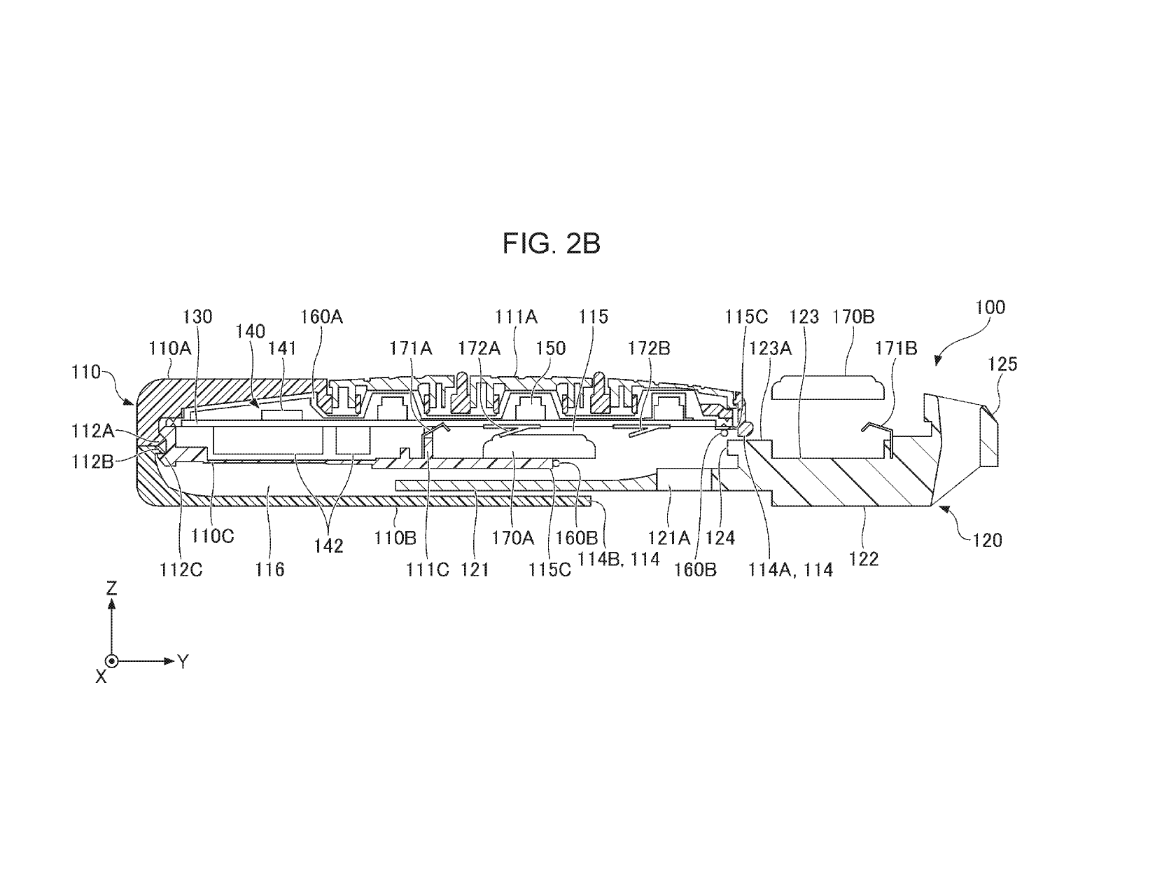

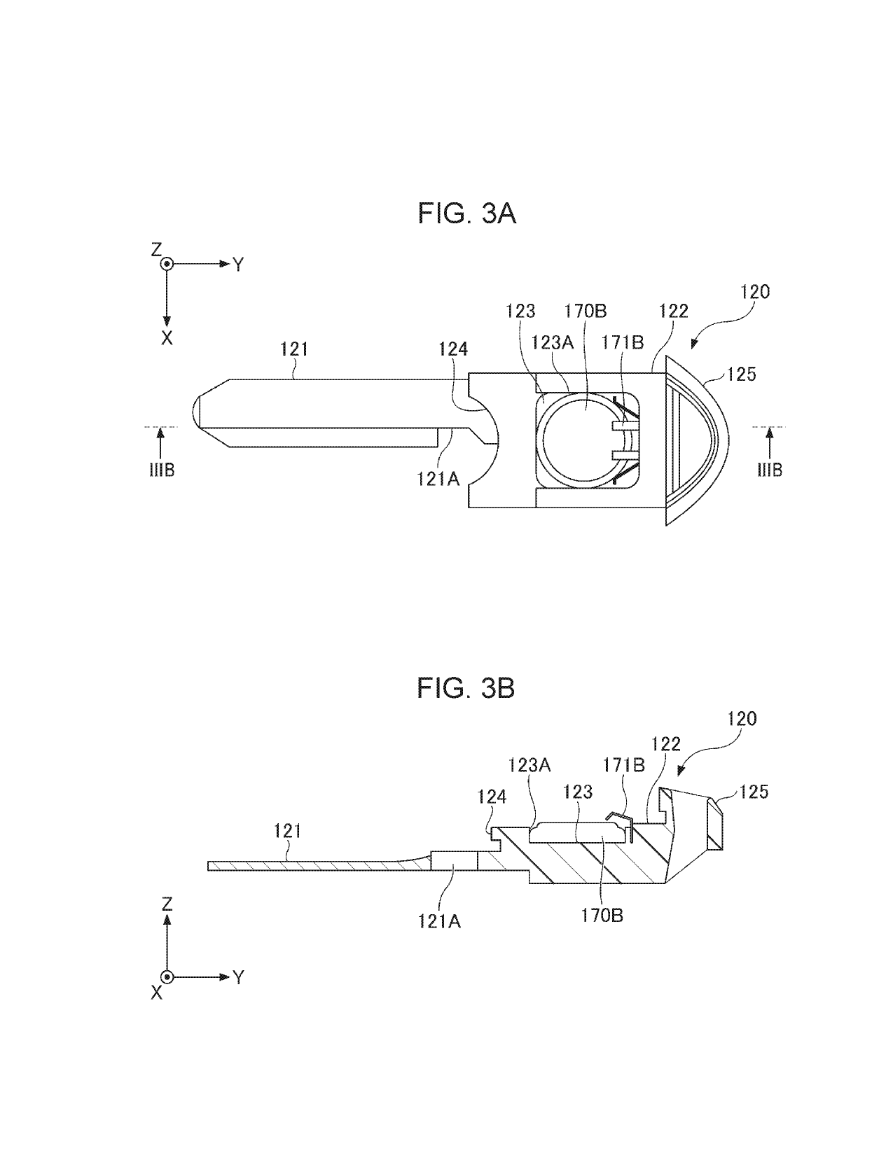

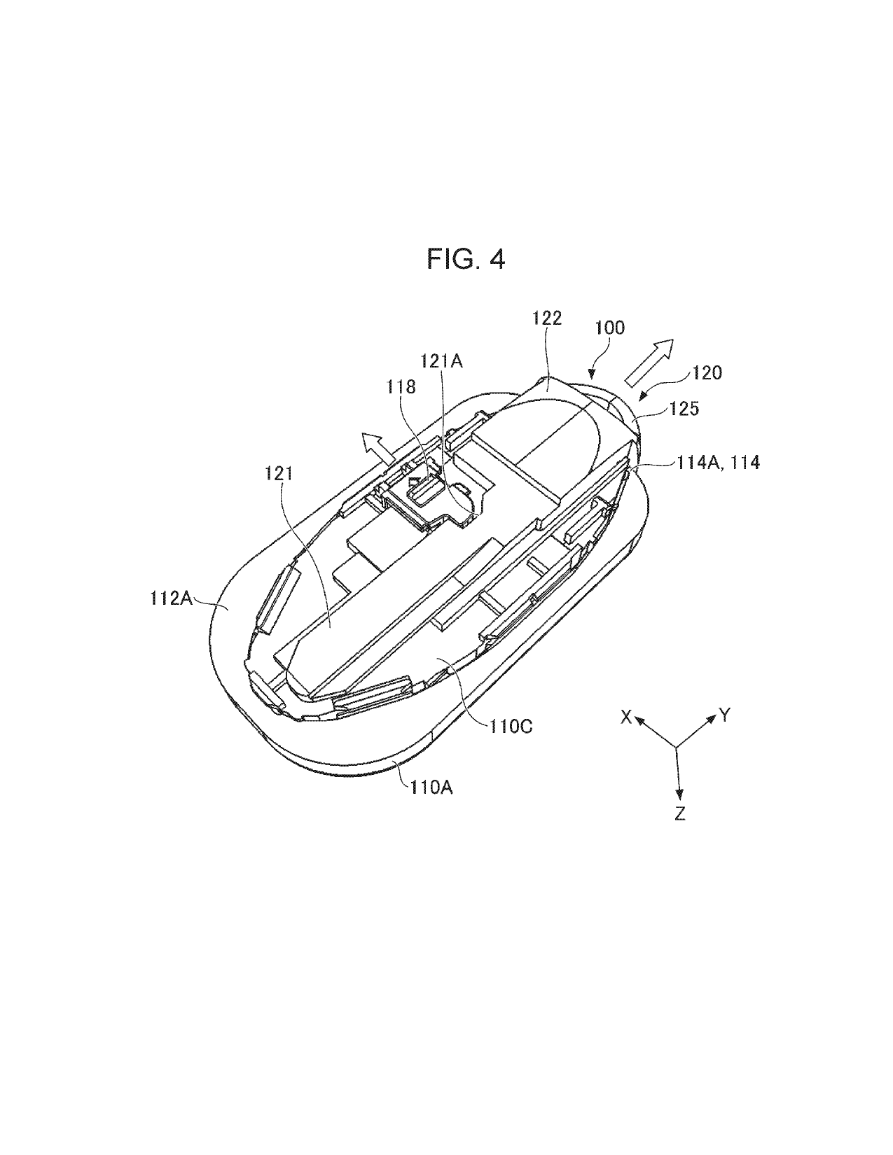

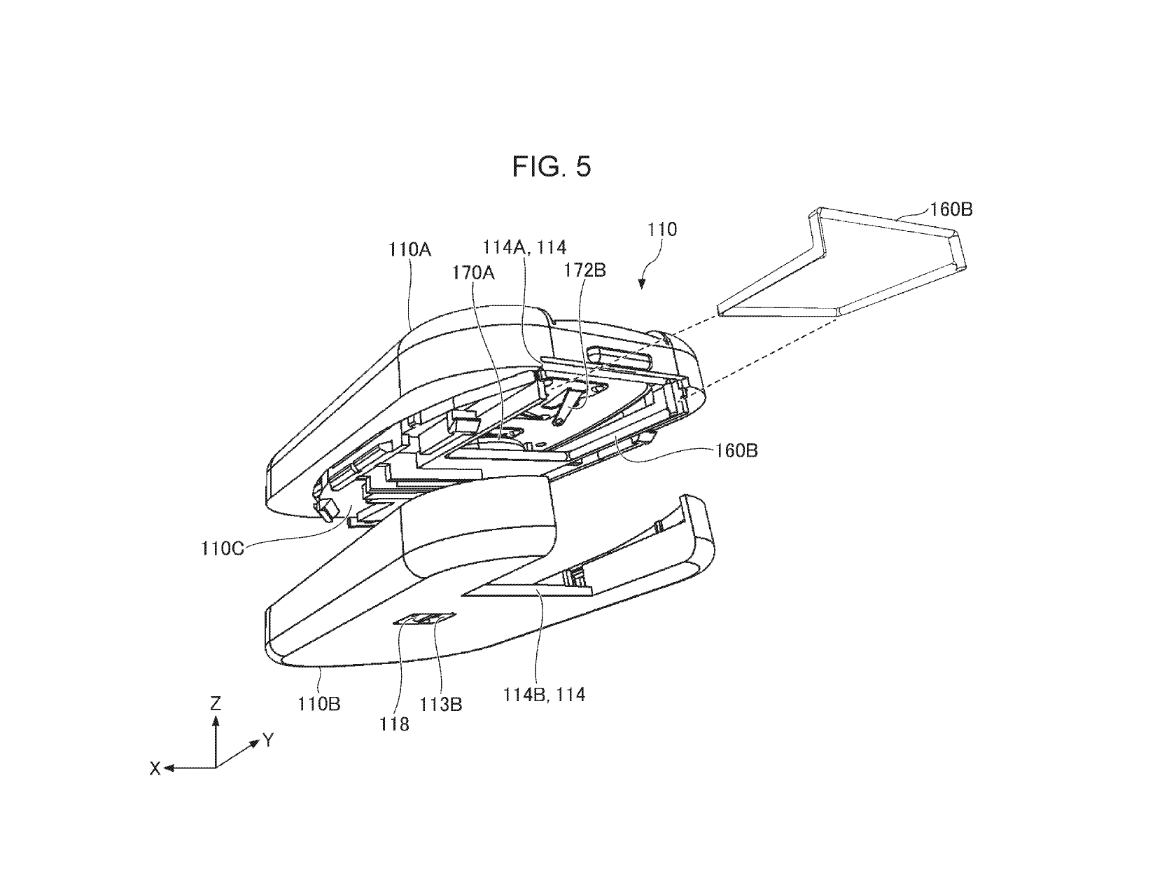

FIG. 2A is a cross-sectional view illustrating an example of the configuration taken along line A-A in FIG. 1A. FIG. 2B is a diagram illustrating an example of a state where the emergency key 120 is pulled out of the housing 110 in FIG. 2A. FIG. 3A is a diagram illustrating an example of the configuration of the emergency key 120. FIG. 3B is a cross-sectional view illustrating an example of the configuration taken along line B-B in FIG. 3A. FIG. 4 is a diagram illustrating an example of a state where a lower housing 110B is removed from the vehicle electronic key 100. FIG. 5 is a diagram illustrating an example of a state where the emergency key 120 is removed from the housing 110 of the vehicle electronic key 100. In order to make the shape of the sealing member 160B easier to understand, FIG. 5 illustrates one additional sealing member 160B outside the housing 110.

The vehicle electronic key 100 is a smart key of a smart key system for a vehicle. The smart key system includes the vehicle electronic key 100 and an in-vehicle device mounted on the vehicle and configured to perform wireless communication with the vehicle electronic key 100. The system enables a user carrying the vehicle electronic key 100 to perform locking and unlocking of components such as door locks, a tailgate, and a fuel lid, as well as turning on and off an ignition switch or a power switch.

### Housing 110

The housing 110 includes an upper housing 110A, a lower housing 110B, a middle housing 110C, an opening 114, a first accommodating compartment 115, and a key accommodating compartment 116. The housing 110 is a rectangular parallelepiped member having its major axis extending in the Y-direction. The housing 110 is made of resin. FIGS. 1A, 1B and 2A illustrate a state where the emergency key 120 is inserted into the housing 110. In this state, a holder portion 125 of the emergency key 120 protrudes in the +Y-direction from the +Y-direction-side end of the housing 110.

The upper housing 110A, the middle housing 110C, and the lower housing 110B are arranged in this order from the +Z-direction side toward the -Z-direction side. Here, for convenience of description, the housings 110A, 110B, and 110C are referred to as the upper housing 110A, the lower housing 110B, and the middle housing 110C, respectively. However, these names do not represent universal upper and lower orientations.

In the following description, the thickness direction of the housing 110 is defined as being the same as the thickness directions of the batteries 170A and 170B, that is, the thickness in the Z-direction. The thickness direction of the housing 110 and the thickness direction of a grip portion 122 of the emergency key 120 are defined as being the same as the thickness directions of the batteries 170A and 170B.

### Upper Housing 110A

The upper housing 110A forms an approximately upper half of the outer surface of the housing 110, and includes an upper wall whose upper surface is exposed to the outside and side walls whose side surfaces are exposed to the outside. The upper housing 110A is provided over the entire X- and Y-directional extents of the upper half of the housing 110. The upper housing 110A includes, as an example, three switches 111A provided on the upper surface, a lower end 112A of the side wall, and a recess 114A formed in the +Y-direction-side side wall and recessed upward from its lower end.

The three switches 111A are arranged along the Y-direction and are respectively disposed in three openings provided in the upper wall of the upper housing 110A. The three switches 111A are, as an example, switches for operating opening and closing of a slide door, unlocking a door lock, and locking the door lock, in this order from the +Y-direction side. As an example of the switches 111A, a button for unlocking and locking a trunk or a panic button may be disposed.

The push-button switches 150 are provided below (i.e., at the back side of) the respective switches 111A. The push-button switches 150 may be, as an example, a TACT Switch^{TM}. The substrate 130 is provided within the upper housing 110A.

As shown in FIGS. 2A and 2B, the lower end 112A of the upper housing 110A is in contact with an upper end 112B of the lower housing 110B. The lower end 112A and the upper end 112B respectively have protrusions that protrude inward in the interiors of the upper housing 110A and the lower housing 110B. The lower end 112A of the upper housing 110A is provided along the entire outer periphery of the upper housing 110A in plan view, except for the +Y-direction-side portion where the recess 114A is located.

The recess 114A is a portion of a lower end of the upper housing 110A that is recessed upward in order to avoid the upper portion of the grip portion 122 of the emergency key 120. The recess 114A is the upper half of the opening 114 (see FIG. 5) of the housing 110 that opens on the +Y-direction side. The recess 114A and a recess 114B of the lower housing 110B are combined to form the opening 114 of the housing 110 shown in FIG. 5.

### Lower Housing 110B

The lower housing 110B forms an approximately lower half of the outer surface of the housing 110, and includes a lower wall whose lower surface is exposed to the outside and side walls whose side surfaces are exposed to the outside. The lower housing 110B is provided over the entire X- and Y-directional extents of the lower half of the housing 110. The lower housing 110B has an upper end 112B of the side wall, an opening 113B provided in the lower wall, and the recess 114B that is recessed from an upper end of a +Y-direction-side side wall toward the lower wall. The upper end 112B has a protrusion that protrudes toward the inside of the lower housing 110B.

The upper end 112B is provided along the entire outer periphery of the lower housing 110B in plan view, except for a +Y-direction-side portion where the recess 114B is located, similarly to the lower end 112A of the upper housing 110A. The recess 114B is a portion of the lower housing 110B that is recessed from the side wall toward the lower surface, as shown in FIG. 1B, in order to avoid the lower portion of the grip portion 122 of the emergency key 120. The recess 114B is the lower half of the opening 114 (see FIG. 5) of the housing 110 that opens on the +Y-direction side. The recess 114B and the recess 114A of the upper housing 110A are combined to form the opening 114 of the housing 110 shown in FIG. 5.

The opening 113B is formed in the lower wall at a position on the +X-direction side of the center of the lower surface of the lower housing 110B, as shown in FIG. 1B, and exposes a protrusion of the lock plate 118 (see FIGS. 1B and 4). The protrusion of the lock plate 118 can be slid in the X-direction by the user of the vehicle electronic key 100 using a finger tip through the opening 113B.

As shown in FIG. 4, the lock plate 118 is a member that, when the emergency key 120 is accommodated in the housing 110, engages the emergency key 120 by being positioned inside the recess 121A of the emergency key 120 so as to prevent the emergency key 120 from coming out of the housing 110. As shown in FIG. 4, the lock plate 118 is attached to the lower surface of the middle housing 110C and is slidable in the X-direction. When the lock plate 118 is slid in the +X-direction (see FIG. 4), the lock plate 118 disengages from the recess 121A of the emergency key 120, whereby the emergency key 120 can be pulled out of the housing 110 in the +Y-direction.

The space between the lower housing 110B and the middle housing 110C forms the key accommodating compartment 116 that accommodates a key plate 121. The key accommodating compartment 116 is covered at its lower side by the lower wall of the lower housing 110B, at its upper side by the middle housing 110C, and on the -X-direction side, the +X-direction side, and the -Y-direction side by the side walls of the lower housing 110B. As shown in FIG. 2B, the key plate 121 is inserted into the key accommodating compartment 116 of the housing 110. Then, as shown in FIG. 2A, the emergency key 120 is inserted into the housing 110 to the deepest position (the most -Y-direction side position), thereby attaching the emergency key 120 to the housing 110. This operation is referred to as attaching the emergency key 120 to the housing 110.

### Middle Housing 110C

The middle housing 110C is a portion of the housing 110 that is located between the upper housing 110A and the lower housing 110B. As shown in FIGS. 2A and 4, when the emergency key 120 is inserted into the housing 110, the middle housing 110C is located below the substrate 130 and is positioned above the key plate 121 of the emergency key 120. As shown in FIG. 4, the middle housing 110C extends from an end on the -Y-direction-side that extends in the X-direction, and extends along the lower end 112A of the upper housing 110A and the upper end 112B of the lower housing 110B up to a position in front of the recesses 114A and 114B on the +Y-direction side.

As shown in FIGS. 2A and 2B, which illustrate portions of the upper housing 110A, the lower housing 110B, and the middle housing 110C, the middle housing 110C includes a partition wall portion 111C, an end portion 112C, and a first opening 115C. The first opening 115C is located at the back side (on the -Y-direction side) of the opening 114 of the housing 110.

As shown in FIGS. 2A and 2B, the partition wall portion 111C is a wall projecting upward from the upper surface of the middle housing 110C. In one example, the upper end of the partition wall portion 111C does not reach the lower surface of the substrate 130, so that a gap is formed. The partition wall portion 111C extends in the X-direction at a central position in the Y-direction of the middle housing 110C. The partition wall portion 111C is provided at the deepest position of the first accommodating compartment 115 that accommodates the battery 170A. As shown in FIG. 2A, the partition wall portion 111C is a wall portion that performs positioning at the deepest position of the first accommodating compartment 115 when the battery 170A is inserted into the first accommodating compartment 115 from the +Y-direction side toward the -Y-direction side.

The end portion 112C is, together with the lower end 112A and the upper end 112B, provided at a portion of the joint portion between the upper housing 110A and the lower housing 110B, except for a portion where the recesses 114A and 114B on the +Y-direction side are provided. The end portion 112C engages the lower end 112A of the upper housing 110A and the upper end 112B of the lower housing 110B.

As shown in FIGS. 2A and 2B, the end portion 112C projects upward and downward at an end of the middle housing 110C, and has a vertical dimension such that the lower end 112A and the upper end 112B can be interposed between the upward and downward projecting portions to allow fitting therewith. The end portion 112C has spring properties and fits with the lower end 112A and the upper end 112B by sandwiching the projecting portions of the lower end 112A and the upper end 112B from above and below. In this manner, the middle housing 110C secures the upper housing 110A and the lower housing 110B together.

The first opening 115C is an opening provided on the +Y-direction side of the middle housing 110C and located on the +Y-direction side of the first accommodating compartment 115. The first opening 115C will be described when the first accommodating compartment 115 is described.

The middle housing 110C fixes the sealing member 160A between the upper end of the end portion 112C and the upper housing 110A, and also fixes the substrate 130 between itself and the upper housing 110A via the sealing member 160A.

### First Accommodating Compartment 115

The first accommodating compartment 115 is a space that accommodates the battery 170A inside the housing 110. The first accommodating compartment 115 is located, in the vertical direction, between the middle housing 110C and the substrate 130, is partitioned on the -Y-direction side by the partition wall portion 111C, and, on the -X-axis-direction side and the +X-direction side, is sandwiched by two wall portions that project upward from the upper surface of the middle housing 110C and extend in the Y-direction. The spacing in the X-direction between the two wall portions located on the -X-direction side and the +X-direction side of the first accommodating compartment 115 is greater than the diameter of the disc-shaped battery 170A, so that the battery 170A can be accommodated.

The first opening 115C is located on the +Y-direction side of the first accommodating compartment 115. The first accommodating compartment 115 is formed so as to be recessed in the -Y-direction from the first opening 115C. The -Y-direction is an example of a first direction.

As shown in FIG. 2B, in a state where the emergency key 120 is not attached to the housing 110, the first accommodating compartment 115 is opened to the +Y-direction side through the first opening 115C. As shown in FIG. 2A, in a state where the emergency key 120 is attached to the housing 110, the +Y-direction side of the first accommodating compartment 115 is closed, with the first opening 115C being blocked by the grip portion 122 of the emergency key 120 and the sealing member 160B.

The first accommodating compartment 115 communicates with the first opening 115C, and the battery 170A is inserted into the first accommodating compartment 115 through the first opening 115C.

The first opening 115C opens along the extending direction of the key plate 121. The key plate 121 extends in the Y-direction. The expression "the first opening 115C opens along the extending direction of the key plate 121" means that the first opening 115C extends in the Y-direction, and the first opening 115C may also extend in a direction other than the Y-direction (the X-direction or the Z-direction). Since the first opening 115C extends in the Y-direction, when the emergency key 120 is inserted toward the -Y-direction side into the housing 110, the movement of the grip portion 122 in the -Y-direction causes the first opening 115C to be closed. This makes it easy to block the first opening 115C.

The first accommodating compartment 115 has a positive terminal 171A and a negative terminal 172A for the battery 170A. The positive terminal 171A and the negative terminal 172A are connected to an integrated circuit (IC) chip 141 via wiring on the substrate 130.

### Emergency Key 120

The emergency key 120 includes the key plate 121, the grip portion 122, a second accommodating compartment 123, a protrusion 124, and the holder portion 125.

The key plate 121 extends in the Y-direction. The grip portion 122 is attached to an end portion of the key plate 121 on the +Y-direction side. In one example, the key plate 121 is made of metal, and the grip portion 122 is made of resin. When the emergency key 120 is attached to the housing 110, the key plate 121 is accommodated in the key accommodating compartment 116 of the housing 110. Accommodation of the key plate 121 within the key accommodating compartment 116 is equivalent to attachment of the emergency key 120 to the housing 110.

As shown in FIGS. 1B and 2A, when the emergency key 120 is attached to the housing 110, the side surface and the lower surface of the grip portion 122 on the +Y-direction side are exposed as part of the outer surface of the vehicle electronic key 100 through the opening 114 formed by the recesses 114A and 114B of the housing 110 (see FIG. 5).

The second accommodating compartment 123 is a portion recessed downward that communicates with a second opening 123A provided on the upper surface of the grip portion 122, and accommodates the battery 170B. The second opening 123A is provided on the upper surface of the grip portion 122 (a surface facing the substrate 130). The second accommodating compartment 123 is provided with a positive terminal 171B and a negative terminal 172B for the terminal 170B. The second accommodating compartment 123 has, in plan view, a rectangular shape circumscribing the circular outer periphery of the disc-shaped battery 170B and is recessed to an appropriate depth suitable for accommodating the battery 170B.

In a state where the key plate 121 is accommodated in the key accommodating compartment 116, the second accommodating compartment 123 may be located on a side of the protrusion 124 opposite to the first accommodating compartment 115. In a state where the key plate 121 is accommodated in the key accommodating compartment 116, the second accommodating compartment 123 is provided below the substrate 130 in the Z-direction. The second accommodating compartment 123 is recessed downward (in a direction away from the substrate 130) from the second opening 123A located on the upper surface of the grip portion 122 in the Z-direction.

When the battery 170B is accommodated in the second accommodating compartment 123, the positive terminal 171B comes into contact with a side surface (positive terminal) of the battery 170B. In a state where the key plate 121 is accommodated in the key accommodating compartment 116, the second accommodating compartment 123 is located on a side of the protrusion 124 opposite to the first accommodating compartment 115.

In one example, the battery 170A accommodated in the first accommodating compartment 115 and the battery 170B accommodated in the second accommodating compartment 123 are connected in parallel via wiring on the substrate 130. By connecting the batteries 170A and 170B in parallel, electric power can be supplied over a long period of time, thereby extending the usable period of the vehicle electronic key 100. However, the batteries 170A and 170B may be connected in series via wiring on the substrate 130. By connecting the batteries 170A and 170B in series, the radio communication range can be increased.

The protrusion 124 projects in the -Y-direction from an end portion on the -Y-direction side of the upper surface of the grip portion 122. The protrusion 124 is an example of a positioning portion, and, as shown in FIG. 3A, a central portion in the X-direction is curved in an arch shape so as to be recessed toward the +Y-direction side in accordance with the shape of the disc-shaped battery 170A.

The holder portion 125 is provided on the +Y-direction side of the grip portion 122 and has a hole through which a key holder or the like can be passed. In a state where the emergency key 120 is attached to the housing 110, the holder portion 125 protrudes to the +Y-direction side of the housing 110.

### Operations of Components When Attaching Emergency Key 120 to Housing 110

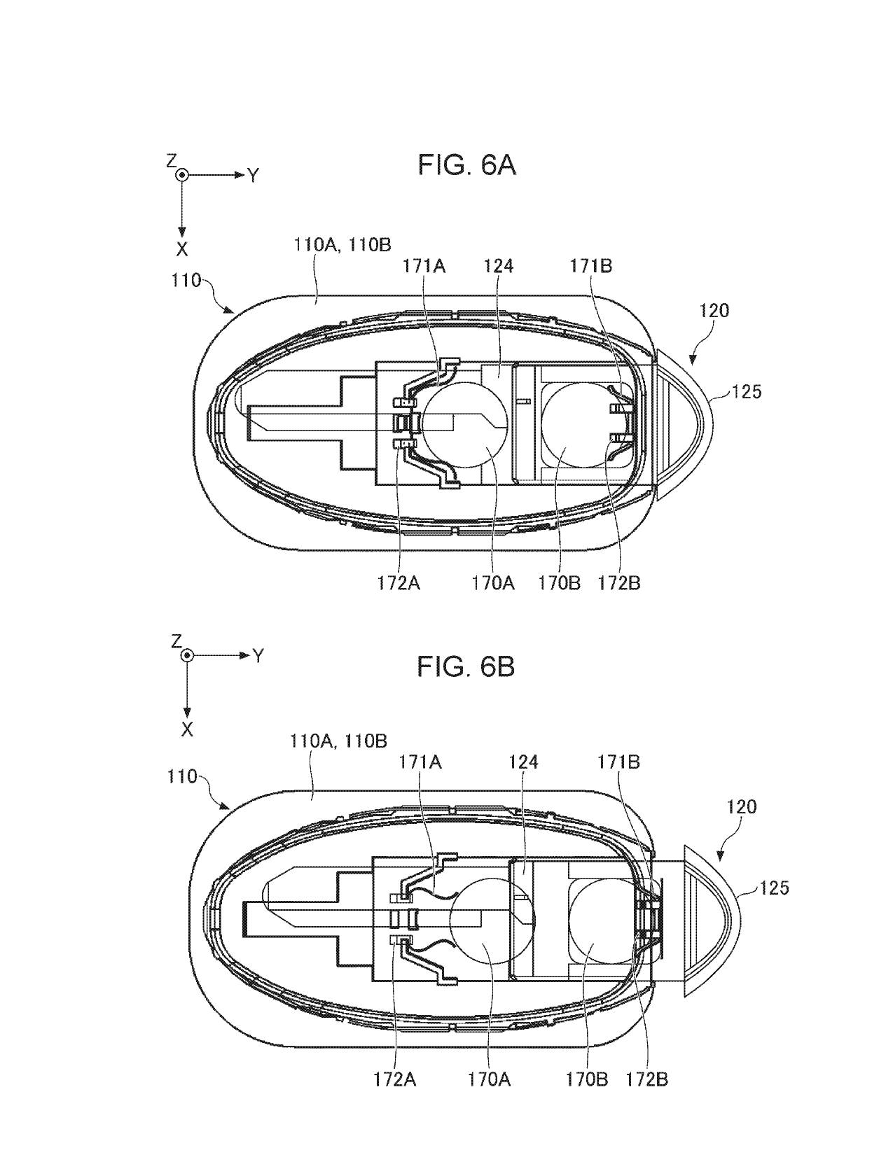

Here, the operations of components when attaching the emergency key 120 to the housing 110 will be described with reference to FIGS. 6A and 6B in addition to FIGS. 2A and 2B. FIGS. 6A and 6B are diagrams illustrating an example of operations of the positive terminal 171A and the protrusion 124 of the emergency key 120 when inserting the battery 170A into the first accommodating compartment 115.

In FIGS. 6A and 6B, only reference signs necessary for explaining the operations are shown, in order to illustrate the components of the vehicle electronic key 100 in a transparent view. FIG. 6A illustrates a state where the emergency key 120 is attached to the housing 110, and FIG. 6B illustrates a state before the emergency key 120 is attached to the housing 110.

As shown in FIG. 6B, the positive terminal 171A includes two S-shaped spring terminals. In a state before the emergency key 120 is attached to the housing 110, the spacing in the X-direction between the two spring terminals is smaller than the diameter of the battery 170A.

As shown in FIG. 2A, when the emergency key 120 is attached to the housing 110, the distal end of the protrusion 124 on the -Y-direction side pushes the battery 170A in the -Y-direction, whereby the battery 170A comes into contact with the partition wall portion 111C on the -Y-direction side and with the protrusion 124 on the +Y-direction side.

In this state, as shown in FIG. 6A, the two S-shaped spring terminals serving as the positive terminal 171A are pushed apart, whereby the two spring terminals hold a side surface (positive terminal) of the battery 170A therebetween in a contact state. In this state, the negative terminals 172A and 172B attached to the lower surface of the substrate 130 come into contact with the negative terminals on the upper surfaces of the batteries 170A and 170B, respectively.

### Substrate 130

The substrate 130 is a wiring board. In one example, a flame-retardant-type-4 (FR-4) multilayer printed circuit board may be used. The IC chip 141, the push-button switches 150, and the like are mounted on the upper surface of the substrate 130. Antennas 142, the negative terminals 172A and 172B, and the like are mounted on the lower surface of the substrate 130. The thickness direction of the substrate 130 is assumed to be the same as the thickness directions of the batteries 170A and 170B.

Since the antennas 142, the first accommodating compartment 115, and the second accommodating compartment 123 are disposed below the substrate 130, and the key accommodating compartment 116 is disposed further below these components, the substrate 130 can be provided over substantially the whole area in the X- and Y-directions within the housing 110. In particular, by disposing the first accommodating compartment 115 and the second accommodating compartment 123, which respectively accommodate the two batteries 170A and 170B, side by side in the Y-direction below the substrate 130, a reduction in the planar area available for arranging the substrate 130 can be prevented, thereby allowing a substrate 130 of sufficient size to be arranged.

### Wireless Communication Unit 140

The wireless communication unit 140 includes the IC chip 141 and two antennas 142. The wireless communication unit 140 performs wireless communication with an in-vehicle device. The IC chip 141 includes a transmitting and receiving circuit and the like, and, in one example, is mounted on the upper surface of the substrate 130. In one example, the IC chip 141 is connected to the two antennas 142 mounted on the lower surface of the substrate 130 and transmits and receives radio waves via the two antennas 142. By the wireless communication unit 140 transmitting and receiving radio waves to and from the in-vehicle device, operations such as locking and unlocking of vehicle components such as a door lock, a tailgate, and a fuel lid, and turning on/off of an ignition switch or a power switch are performed.

In the vehicle electronic key 100 as described above, the antennas 142, the first accommodating compartment 115, and the second accommodating compartment 123 are arranged in the extending direction (Y-direction) of the key plate 121. The antenna 142, the first accommodating compartment 115, and the second accommodating compartment 123 are arranged in this order in the extending direction (Y-direction) of the key plate 121.

### Push-Button Switch 150

In one example, three push-button switches 150 are mounted on the upper surface of the substrate 130 along the Y-direction and are covered with the sealing member 160A. The push-button switches 150 are respectively provided below the switches 111A of the upper housing 110A. When the user presses each switch 111A downward, the corresponding push-button switch 150 is actuated.

### Sealing Member 160A

The sealing member 160A is a rubber sheet-like sealing member disposed on the upper surface side of the substrate 130 to cover the IC chip 141, the push-button switches 150, and the like. In one example, the sealing member 160A has an uneven shape corresponding to the protrusions and recesses of the IC chip 141, the push-button switches 150, and the like.

In plan view, the outer periphery of the sealing member 160A, except in a region where the recess 114A of the upper housing 110A is located, is clamped and fixed between the upper end of the end portion 112C of the middle housing 110C and the upper housing 110A when the upper housing 110A, the lower housing 110B, and the middle housing 110C are assembled. In plan view, the outer periphery of the sealing member 160A, in a region where the recess 114A of the upper housing 110A is located, is clamped and fixed between the peripheral portion of the recess 114A of the upper housing 110A and a portion on the +Y-direction side of the first opening 115C of the middle housing 110C. At this time, the substrate 130 is clamped and fixed between the upper housing 110A and the middle housing 110C via the sealing member 160A.

### Sealing Member 160B

As shown in FIGS. 2B and 5, the sealing member 160B is a substantially rectangular-ring-shaped sealing member provided along the first opening 115C. The sealing member 160B is made of rubber. The sealing member 160B is a ring-shaped member formed by annularly connecting six linear portions, namely: two portions extending in the Y-direction on the -X-direction and +X-direction sides; two portions extending in the Z-direction on the -X-direction and +X-direction sides, and two portions extending in the X-direction on the -Y-direction and +Y-direction sides.

A portion extending in the X-direction on the -Y-direction side is connected between -Y-direction side end portions of the two portions extending in the Y-direction on the -X-direction and +X-direction sides. The lower ends of the two portions extending in the Z-direction on the -X-direction and +X-direction sides are respectively connected to the +Y-direction side end portions of the two portions extending in the Y-direction on the -X-direction and +X-direction sides. A portion extending in the X-direction on the +Y-direction side is connected between the upper ends of the two portions extending in the Z-direction on the -X-direction and +X-direction sides.

For this reason, the sealing member 160B has an L-shape in Y-Z plan view. In plan view, the sealing member 160B has a rectangular ring shape because the two portions extending in the Y-direction on the -X-direction and +X-direction sides and the two portions extending in the X-direction on the -Y-direction and +Y-direction sides are visible, whereas the two portions extending in the Z-direction on the -X-direction and +X-direction sides are not visible. Of the sealing member 160B, the portion extending in the X-direction on the -Y-direction side is located below the portion extending in the X-direction on the +Y-direction side. This is because it corresponds to the shape of the first opening 115C of the middle housing 110C.

As shown in FIG. 2A, when the emergency key 120 is attached to the housing 110, the sealing member 160B is sandwiched between a portion of the lower surface of the middle housing 110C extending along the first opening 115C and the grip portion 122. More specifically, the sealing member 160B comes into contact with a peripheral portion of the upper surface of the grip portion 122 around the second accommodating compartment 123, and with a portion of the grip portion 122 located below the protrusion 124. In other words, the sealing member 160B is provided along the joint portion between the first opening 115C and the grip portion 122.

In this state, the spacing between the first opening 115C of the middle housing 110C and the grip portion 122 of the emergency key 120 is sealed by the sealing member 160B. In other words, in a state where the emergency key 120 is attached to the housing 110, the sealing member 160B seals the joint portion between the first opening 115C and the grip portion 122. The spacing surrounded by the middle housing 110C and the sealing member 160A, other than the first opening 115C, is sealed by the middle housing 110C and the sealing member 160A.

For this reason, by attaching the emergency key 120 to the housing 110 and sealing the first opening 115C with the grip portion 122, an enclosed space is formed, which is sealed by the middle housing 110C, the sealing member 160A, and the grip portion 122. This enclosed space includes the first accommodating compartment 115 and the second accommodating compartment 123.

In other words, simply by attaching the emergency key 120 to the housing 110, an internal enclosed space can be easily obtained. Since the enclosed space contains the substrate 130, the wireless communication unit 140, the push-button switches 150, and the batteries 170A and 170B, waterproofness can be ensured. Since the vehicle electronic key 100 includes the substrate 130, the wireless communication unit 140, the push-button switches 150, the batteries 170A and 170B, and the like, it is necessary to ensure waterproofness.

Simply by removing the emergency key 120 from the housing 110, the batteries 170A and 170B accommodated in the first accommodating compartment 115 and the second accommodating compartment 123 can be replaced.

More specifically, the battery 170A is accommodated in the first accommodating compartment 115 of the housing 110 and can be easily replaced simply by removing the emergency key 120 from the housing 110. The battery 170B is accommodated in the second accommodating compartment 123 provided in the grip portion 122 of the emergency key 120, and can be easily replaced simply by removing the emergency key 120 from the housing 110. In addition, the emergency key 120 can be removed from the housing 110 simply by sliding the lock plate 118 in the +X-direction and pulling the emergency key 120 out of the housing 110, without requiring tools or special tools. The vehicle electronic key 100 is configured such that the batteries 170A and 170B can be replaced without using tools or special tools, thereby providing high safety.

### Advantageous Effects

A vehicle electronic key 100 according to the present disclosure includes a housing 110 including a key accommodating compartment 116, a first opening 115C, and a first accommodating compartment 115 that communicates with the first opening 115C and is configured to accommodate a battery 170A; a wireless communication unit 140 accommodated within the housing 110; and an emergency key 120 including a key plate 121 accommodated in the key accommodating compartment 116 and a grip portion 122 attached to the key plate 121, wherein the grip portion 122 includes a second opening 123A, a second accommodating compartment 123 that communicates with the second opening 123A and is configured to accommodate a battery 170B, and a protrusion 124 that, when the key plate 121 is accommodated in the key accommodating compartment 116, comes into contact with the battery 170A accommodated in the first accommodating compartment 115, and wherein, when the key plate 121 is accommodated in the key accommodating compartment 116, the first opening 115C is blocked by the grip portion 122, and the first accommodating compartment 115 and the second accommodating compartment 123 are contained in an enclosed space closed by the housing 110 and the grip portion 122. In the vehicle electronic key 100, the batteries 170A and 170B can be respectively taken out of the first accommodating compartment 115 and the second accommodating compartment 123, which are contained in the enclosed space, simply, by removing the emergency key 120 from the housing 110. Furthermore, when the emergency key 120 is attached to the housing 110, the batteries 170A and 170B can be accommodated in the first accommodating compartment 115 and the second accommodating compartment 123, which are contained in the enclosed space. At this time, the battery 170A can be positioned within the first accommodating compartment 115. Accordingly, battery replacement can be easily performed without using tools or special tools when the emergency key 120 is removed from the housing 110 and subsequently attached to the housing 110. When the two batteries 170A and 170B are connected in parallel, the usable time until battery replacement can be extended, while when the two batteries 170A and 170B are connected in series, the radio-wave transmission range can be increased.

Accordingly, the vehicle electronic key 100 in which battery replacement can be easily performed, the usable time until battery replacement is long, or the radio-wave transmission range is long can be provided.

When the key plate 121 is accommodated in the key accommodating compartment 116, the key plate 121 may project from the grip portion 122 in the -Y-direction. The first accommodating compartment 115 may be formed so as to be recessed from the first opening 115C in the -Y-direction. The protrusion 124 may project from the grip portion 122 in the -Y-direction and, when the key plate 121 is accommodated in the key accommodating compartment 116, may push the battery 170A toward the -Y-direction side of the first accommodating compartment 115. When the emergency key 120 is attached to the housing 110, the protrusion 124 can push the battery 170A in the -Y-direction (deeper portion) of the first accommodating compartment 115, whereby battery replacement can be easily performed.

When the key plate 121 is accommodated in the key accommodating compartment 116, the second accommodating compartment 123 may be located on a side of the protrusion 124 opposite to the first accommodating compartment 115. As a result, the second accommodating compartment 123 can be provided within the grip portion 122. By disposing the two batteries 170A and 170B along the extending direction (Y-direction) of the key plate 121, the vehicle electronic key 100 capable of accommodating the two batteries 170A and 170B can be provided without increasing the size of the housing 110.

Another vehicle electronic key 100 according to the present disclosure includes a housing 110 including a key accommodating compartment 116, a first opening 115C, and a first accommodating compartment 115 that communicates with the first opening 115C and is configured to accommodate a battery 170A; a wireless communication unit 140 accommodated within the housing 110; and an emergency key 120 including a key plate 121 accommodated in the key accommodating compartment 116 and a grip portion 122 attached to the key plate 121, wherein the grip portion 122 includes a second opening 123A and a second accommodating compartment 123 that communicates with the second opening 123A and is configured to accommodate a battery 170B, wherein, when the key plate 121 is accommodated in the key accommodating compartment 116, the battery 170A accommodated in the first accommodating compartment 115 and the battery 170B accommodated in the second accommodating compartment 123 are connected in parallel, and wherein, when the key plate 121 is accommodated in the key accommodating compartment 116, the first opening 115C is blocked by the grip portion 122, and the first accommodating compartment 115 and the second accommodating compartment 123 are contained within an enclosed space closed by the housing 110 and the grip portion 122. In the vehicle electronic key 100, when the emergency key 120 is removed from the housing 110, the batteries 170A and 170B can be respectively taken out of the first accommodating compartment 115 and the second accommodating compartment 123, which are contained in the enclosed space, while when the emergency key 120 is attached to the housing 110, the batteries 170A and 170B can be respectively accommodated in the first accommodating compartment 115 and the second accommodating compartment 123, which are contained in the enclosed space. Thus, battery replacement can be easily performed without using tools or special tools. Furthermore, because the two batteries 170A and 170B are connected in parallel, the usable time until battery replacement can be extended.

Accordingly, the vehicle electronic key 100 in which battery replacement can be easily performed, and the usable time until battery replacement is long can be provided.

The vehicle electronic key may further include a sealing member 160B provided along a joint portion between the first opening 115C and the grip portion 122, the sealing member sealing the joint portion when the key plate 121 is accommodated in the key accommodating compartment 116. By sealing the joint portion between the first opening 115C and the grip portion 122 to ensure waterproofness, electrical reliability can be improved.

The vehicle electronic key may further include a substrate 130 provided within the enclosed space, the substrate having an electronic component mounted thereon, wherein thickness directions of the housing 110, the grip portion 122, and the substrate 130 may be the same as thickness directions of the battery 170A and the battery 170B, wherein, when the key plate 121 is accommodated in the key accommodating compartment 116, the second accommodating compartment 123 may be provided on one side of (below) the substrate 130 in the thickness direction, wherein the second opening 123A may be provided on a surface (upper surface) of the grip portion 122 facing the substrate 130, and wherein the second accommodating compartment 123 may be recessed from the second opening 123A in a direction away from the substrate 130 (downward). Since the second accommodating compartment 123 provided below the substrate 130 is recessed downward from the upper surface of the grip portion 122, the accommodation space for the battery 170B can be efficiently ensured without increasing the size of the housing 110.

The wireless communication unit 140 may include an antenna 142, wherein the antenna 142 may be provided on the one side of the substrate 130, and wherein the antenna 142, the first accommodating compartment 115, and the second accommodating compartment 123 may be arranged in an extending direction (Y-direction) of the key plate 121. Since the key plate 121 has a certain length, and the antenna 142, the first accommodating compartment 115, and the second accommodating compartment 123 are arranged in the extending direction (Y-direction) of the key plate 121, the accommodation space for the two batteries 170A and 170B can be efficiently ensured without increasing the size of the housing 110 in its longitudinal direction.

The antenna 142, the first accommodating compartment 115, and the second accommodating compartment 123 may be arranged in this order in the extending direction of the key plate 121. This enables a configuration in which the two batteries 170A and 170B can be easily replaced within the limited space inside the housing 110.

The first opening 115C may open along the extending direction (Y-direction) of the key plate 121 and, when the key plate 121 is accommodated in the key accommodating compartment 116, may surround the second opening 123A in plan view. Since the first opening 115C opens along the Y-direction, when the emergency key 120 is inserted into the housing 110, movement of the grip portion 122 in the -Y-direction closes the first opening 115C. This makes it easy to block the first opening 115C. Furthermore, with the key plate 121 accommodated in the key accommodating compartment 116, the first opening 115C surrounds the second opening 123A in plan view, whereby the second accommodating compartment 123 is contained in a space surrounded by the first opening 115C and the grip portion 122. Accordingly, by attaching the emergency key 120 to the housing 110, an enclosed space that contains the first accommodating compartment 115 and the second accommodating compartment 123 can be easily formed.

Thickness directions of the housing 110 and the grip portion 122 may be the same as thickness directions of the battery 170A and the battery 170B. The key accommodating compartment 116 may be provided on one side (lower side) of the first accommodating compartment 115 in the thickness direction. Since the key plate 121 is the longest among the components of the emergency key 120, an accommodation space for it needs to be specially arranged. By disposing the key accommodating compartment 116 for accommodating such a key plate 121 on the lower side of the first accommodating compartment 115, a configuration in which the key plate 121 can be disposed in a limited space within the housing 110 can be achieved.

Although a vehicle electronic key according to an exemplary embodiment of the present disclosure has been described above, the present disclosure is not limited to the specifically disclosed embodiment, and various modifications and changes may be made without departing from the scope of the claims.

The following additional notes (Examples) are disclosed with respect to the above embodiment.

### Additional Note: Example 1

A vehicle electronic key comprises (a) a housing including a key accommodating compartment, a first opening, and a first accommodating compartment that communicates with the first opening and is configured to accommodate a first battery; (b) a wireless communication unit accommodated within the housing, and (c) an emergency key including a key plate accommodated in the key accommodating compartment and a grip portion attached to the key plate, wherein the grip portion includes a second opening, a second accommodating compartment that communicates with the second opening and is configured to accommodate a second battery, and a positioning portion. When the key plate is accommodated in the key accommodating compartment, the positioning portion comes into contact with the first battery accommodated in the first accommodating compartment. In addition, when the key plate is accommodated in the key accommodating compartment, the first opening is blocked by the grip portion, and the first accommodating compartment and the second accommodating compartment are contained within an enclosed space closed by the housing and the grip portion.

### Additional Note: Example 2

In the vehicle electronic key according to Example 1, when the key plate is accommodated in the key accommodating compartment, the key plate projects from the grip portion in a first direction. The first accommodating compartment is formed so as to be recessed from the first opening in the first direction. The positioning portion projects from the grip portion in the first direction and, when the key plate is accommodated in the key accommodating compartment, pushes the first battery toward the first direction side of the first accommodating compartment.

### Additional Note: Example 3

In the vehicle electronic key according to Example 2, when the key plate is accommodated in the key accommodating compartment, the second accommodating compartment is located on a side of the positioning portion opposite to the first accommodating compartment.

### Additional Note: Example 4

A vehicle electronic key comprises (a) a housing including a key accommodating compartment, a first opening, and a first accommodating compartment that communicates with the first opening and is configured to accommodate a first battery, (b) a wireless communication unit accommodated within the housing, and (c) an emergency key including a key plate accommodated in the key accommodating compartment and a grip portion attached to the key plate, wherein the grip portion includes a second opening and a second accommodating compartment that communicates with the second opening and is configured to accommodate a second battery. When the key plate is accommodated in the key accommodating compartment, the first battery accommodated in the first accommodating compartment and the second battery accommodated in the second accommodating compartment are connected in parallel. When the key plate is accommodated in the key accommodating compartment, the first opening is blocked by the grip portion, and the first accommodating compartment and the second accommodating compartment are contained within an enclosed space closed by the housing and the grip portion.

### Additional Note: Example 5

The vehicle electronic key according to any one of Examples 1 to 4, may further comprise (d) a sealing member provided along a joint portion between the first opening and the grip portion, the sealing member sealing the joint portion when the key plate is accommodated in the key accommodating compartment.

### Additional Note: Example 6

The vehicle electronic key according to any one of Examples 1 to 5, may further comprise (e) a substrate provided within the enclosed space, the substrate having an electronic component mounted thereon. The thickness directions of the housing, the grip portion, and the substrate are the same as thickness directions of the first battery and the second battery. When the key plate is accommodated in the key accommodating compartment, the second accommodating compartment is provided on one side of the substrate in the thickness direction. The second opening is provided on a surface of the grip portion facing the substrate. The second accommodating compartment is recessed from the second opening in a direction away from the substrate.

### Additional Note: Example 7

In the vehicle electronic key according to Example 6, the wireless communication unit includes an antenna, where the antenna is provided on the one side of the substrate, and the antenna, the first accommodating compartment, and the second accommodating compartment are arranged in an extending direction of the key plate.

### Additional Note: Example 8

In the vehicle electronic key according to Example 7, the antenna, the first accommodating compartment, and the second accommodating compartment are arranged in this order in the extending direction of the key plate.

### Additional Note: Example 9

In the vehicle electronic key according to any one of Examples 1 to 8, the first opening opens along an extending direction of the key plate and, when the key plate is accommodated in the key accommodating compartment, surrounds the second opening in plan view.

### Additional Note: Example 10

In the vehicle electronic key according to any one of Examples 1 to 9, the thickness directions of the housing and the grip portion are the same as thickness directions of the first battery and the second battery, and the key accommodating compartment is provided on one side of the first accommodating compartment in the thickness direction.

What is claimed is:

1. A vehicle electronic key comprising:
a housing including a key compartment, a first opening, and a first compartment for accommodating a first battery, the first compartment communicating with the first opening;
a wireless communication unit accommodated within the housing; and
an emergency key including a key plate extending in a first direction when accommodated in the key compartment, and a grip portion attached to the key plate,
wherein the grip portion includes:
a second opening;
a second compartment for accommodating a second battery, the second compartment communicating with the second opening; and
a positioning portion that, when the key plate is accommodated in the key compartment, comes into contact with the first battery accommodated in the first compartment,
and wherein, when the key plate is accommodated in the key compartment, the first opening is closed up by the grip portion, and the first compartment and the second compartment are contained within a closed space enclosed by the housing and the grip portion.

2. The vehicle electronic key according to claim 1, wherein, when the key plate is accommodated in the key compartment, the key plate projects from the grip portion in the first direction,
wherein the first compartment is recessed in the first direction with respect to the first opening,
and wherein the positioning portion projects from the grip portion in the first direction and, when the key plate is inserted in the key compartment, pushes the first battery in the first direction into the first compartment.

3. The vehicle electronic key according to claim 2, wherein, when the key plate is accommodated in the key compartment, the second compartment is located on a side opposite to the first compartment with respect to the positioning portion.

4. A vehicle electronic key comprising:
a housing including a key compartment, a first opening, and a first compartment for accommodating the first battery, the first compartment communicating that communicates with the first opening;
a wireless communication unit accommodated within the housing; and
an emergency key including a key plate accommodated in the key compartment and a grip portion attached to the key plate,
wherein the grip portion includes a second opening and a second compartment for accommodating a second battery, the second compartment communicating with the second opening
and wherein, when the key plate is accommodated in the key compartment, the first battery accommodated in the first compartment and the second battery accommodated in the second compartment are connected in parallel, the first opening is closed up by the grip portion, and the first compartment and the second compartment are contained within a closed space enclosed by the housing and the grip portion.

5. The vehicle electronic key according to claim 1, further comprising a sealing member provided along a joint portion between the first opening and the grip portion, the sealing member sealing the joint portion when the key plate is accommodated in the key compartment.

6. The vehicle electronic key according to claim 1, further comprising:
a substrate provided within the closed space and having a thickness in a second direction, the substrate having an electronic component mounted thereon,
wherein the housing, the grip portion, the first battery, and the second battery have a respective thickness in the second direction,
wherein, when the key plate is accommodated in the key compartment, the second compartment is provided on one side of the substrate in the second direction,
wherein the second opening is provided on a surface of the grip portion facing the substrate, and
wherein the second compartment is recessed in a direction away from the substrate with respect to the second opening.

7. The vehicle electronic key according to claim 6,
wherein the wireless communication unit includes an antenna provided on the one side of the substrate, and
wherein the antenna, the first compartment, and the second compartment are arranged in the first direction.

8. The vehicle electronic key according to claim 7, wherein the antenna, the first compartment, and the second compartment are arranged in this order in the first direction.

9. The vehicle electronic key according to claim 1, wherein the first opening s formed along the first direction and, when the key plate is accommodated in the key compartment, surrounds the second opening in a plan view from a second direction which is a thickness direction of the key plate.

10. The vehicle electronic key according to claim 1,
wherein the housing, the grip portion, the first battery, and the second battery have a respective thickness in a second direction, and
wherein the key accommodating compartment is provided on one side of the first compartment in the second direction.
